(19) United States
(12) Patent Application Publication
(10) Pub. No.: US 2023/0293384 A1
(43) Pub. Date: Sep. 21, 2023

(54) Skin Care Device With Improved Removable Massage Head Drive

(71) Applicant: SEB S.A., Ecully (FR)

(72) Inventor: Yohan Dassonville, Dardilly (FR)

(73) Assignee: SEB S.A., Ecully (FR)

(21) Appl. No.: 18/021,299

(22) PCT Filed: Aug. 10, 2021
(86) PCT No.: PCT/EP2021/072317

§ 371 Date: Feb. 14, 2023

(30) Foreign Application Priority Data
Aug. 14, 2020 (FR) FR2008499

(51) Int. Cl. A61H 15/00

(52) U.S. Cl. CPC A61H 15/0085; A61H 2015/0007; A61H 2201/0107; A61H 2201/1215; A61H 2205/022

(57) ABSTRACT

A skin care device includes
a massage head,
a body to which the head is intended to be removably attached. The body includes a housing and a motor for actuating the head, and
a coupling system for transmitting rotation from the motor to the head. The coupling system includes first and second coupling members, one of which constitutes a male member and the other constitutes a female member intended to receive the male member to cooperate with the male member in a form-fitting manner. The
first coupling member is mounted in a substantially rotational manner relative to the housing, and the male member hasa general conical shape and including fins the free edges of which define the general conical shape.

The present invention relates to the general technical field of devices for skin care or skin massage, especially the face, in particular for household use.

The present invention relates more specifically to the technical field of skin care devices comprising at least one massage head, a main body to which said massage head is intended to be removably attached, said main body comprising a housing forming a manual gripping area and a motor for actuating the massage head. The present invention also relates to the technical fields of massage heads and main bodies of such skin care devices.

There are already known skin care devices, and in particular for massaging the skin, which generally consist of a main body forming a gripping handle and within which a motor is arranged, and of a massage head connected to the handle and intended to be applied in contact with the skin to perform a massaging action on the latter. The massage head is actuated by the motor arranged in the handle by means of a mechanical transmission mechanism between the motor and the moving parts of the massage head.

In order to allow the user to alternately use different massage heads in combination with a same handle, devices with massage heads designed to be removably attached to the handle have been proposed. The mechanical transmission mechanism between the motor and the massage head is thus designed to allow temporary mechanical coupling between the motor and the massage head. For example, one known device comprises a drive shaft with a polygonal cross-section incorporated in the main body, the shaft being intended to fit into a cavity in the massage head that has a corresponding shape for driving the massage head when the head is mounted on the main body.

Although such known skin care devices are generally satisfactory, they can still be improved in terms of the ease and speed with which the user can assemble the massage head to the main body forming a handle of the device. Indeed, such skin care devices, designed to perform a mechanical skin massage, generally comprise mechanical elements intended to be set in motion at low speeds or frequencies, typically from a few rotations per minute (that is, a few hertz) to a hundred rotations per minute. The motor used must therefore be associated with a high degree of reduction, for example by means of a gearmotor. Because the drive shaft is rotationally connected to the motor via high torque, it is difficult for the shaft to rotate when the motor is stopped. Thus, when assembling a massage head to the main body, the user usually has to resort to trial and error, by changing the spatial orientation of the selected massage head to eventually find the correct relative position of the massage head with respect to the main body allowing the assembly of the two elements and the temporary mechanical coupling between the motor and the massage head. The use of the device, particularly the operation of assembling the massage head to the main body, can therefore be particularly complicated and painstaking, which can be prohibitive in particular for household use of the device. This is especially true when the massage head selected by the user is designed to be attached to the main body in a single predetermined relative position.

The purposes of the invention are therefore to provide a response to the aforementioned needs and problems and to provide a new skin care device with at least one massage head that can be especially quickly and easily assembled to the main body of the device by a user, while being particularly simple in design.

Another purpose of the invention is to provide a new skin care device that is particularly simple to use, in particular by a user with no specific professional skills in skin massage.

Another purpose of the invention is to provide a new skin care device with at least one massage head that can be easily attached to and detached from the main body, with no risk of deteriorating the motor and mechanical elements of the massage head and main body.

Another purpose of the invention is to provide a new skin care device with at least one massage head that can be mounted in a single operating position and can be intuitively mounted in this position.

Another purpose of the invention is to provide a new skin care device that is particularly robust and reliable.

Another purpose of the invention is to provide a new skin care device with a compact design.

Another purpose of the invention is to provide a new skin care device that is particularly quiet and pleasant to use, and which provides a high level of perceived quality.

The purposes of the invention are achieved by means of a skin care device comprising:
at least one massage head,
a main body to which said massage head is intended to be removably attached, said main body comprising a housing forming a manual gripping area and a motor for actuating the massage head, and
a temporary mechanical coupling system between the massage head and the main body for transmitting to the massage head a rotational movement of a shaft driven by the motor, said mechanical coupling system comprising a first coupling member and a second coupling member that belong to the main body and the massage head, respectively, one of said coupling members constituting a male coupling member, the other of said coupling members constituting a female coupling member intended to receive the male coupling member therein in order to cooperate with it in a form-fitting manner, the first coupling member being mounted in a purely rotational manner with respect to the main body housing, said male coupling member having a general conical or frustoconical shape and including a plurality of fins distributed around the axis of rotation of the male coupling member, said fins having free edges that define said general conical or frustoconical shape.

The purposes of the invention are also achieved by means of a massage head for a skin care device, in accordance with the foregoing and wherein the first coupling member constitutes said male coupling member, while the second coupling member constitutes said female coupling member, wherein said female coupling member has a general conical or frustoconical shape having a taper angle comprised between 5° and 30°, preferably comprised between 10° and 20°, even more preferably equal to 15° ± 2°.

The purposes of the invention are also achieved by means of a main body for a skin care device in accordance with the foregoing and wherein the first coupling member constitutes said male coupling member, while the second coupling member constitutes said female coupling member.

Other features and advantages of the invention will become apparent and more detailed on reading the following description, with reference to the attached drawings, which are provided only as illustrative and non-limitative examples, in which:

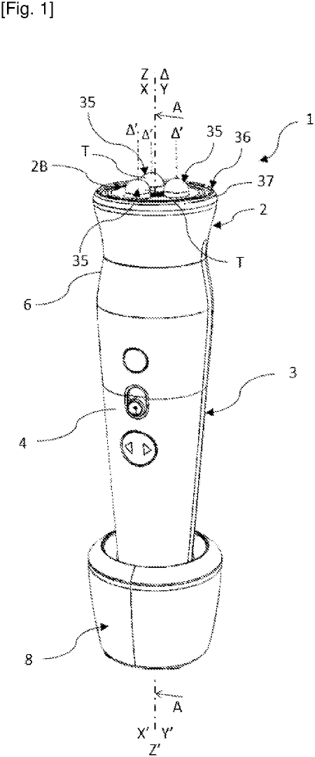

FIG. 1 depicts a side view in perspective of an embodiment of a care device according to the invention, a removable massage head being attached to the main body of the device;

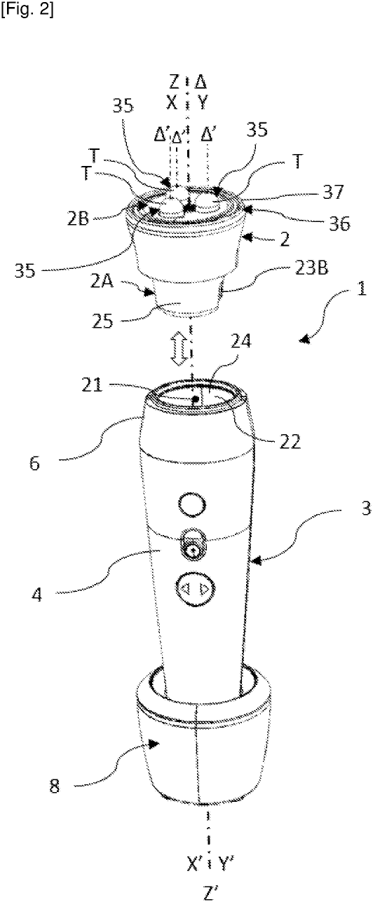

FIG. 2 depicts, in a side view in perspective, the device in FIG. 1, the removable massage head being detached from the main body;

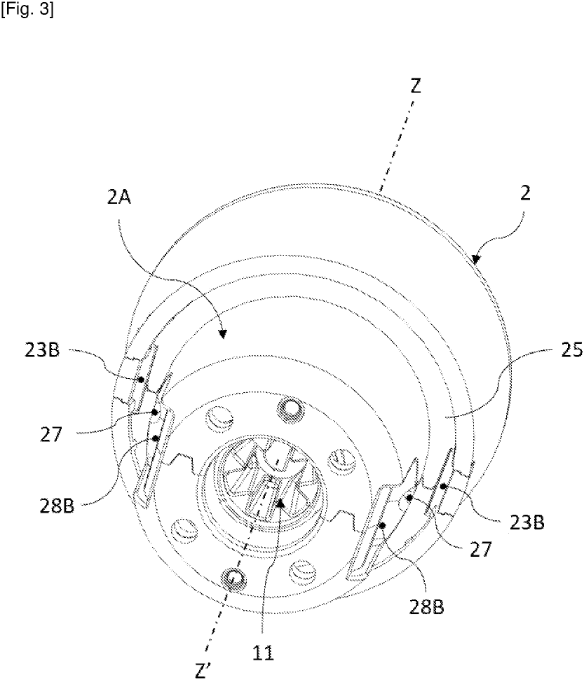

FIG. 3 depicts, in a bottom view in perspective, the massage head of the device in FIGS. 1 and 2;

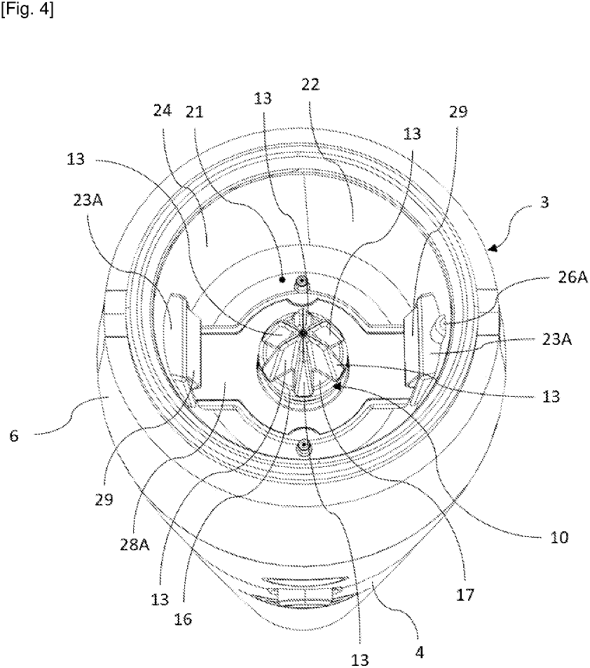

FIG. 4 depicts, in a top view in perspective, the main body of the device in FIGS. 1 and 2;

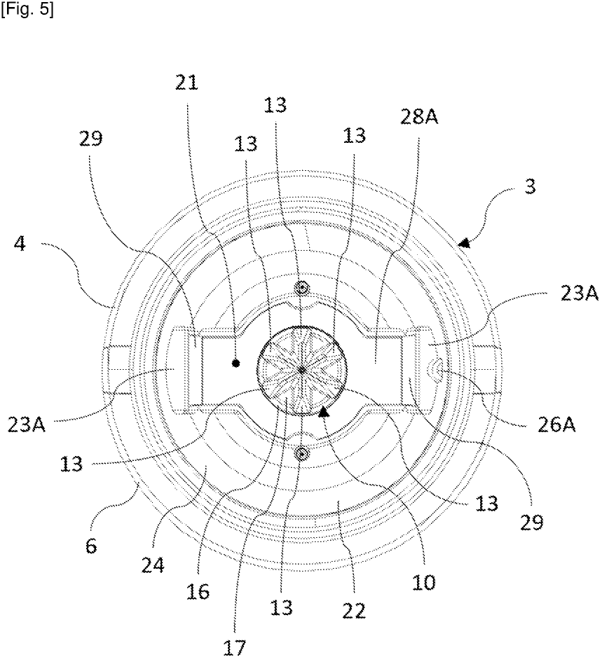

FIG. 5 depicts a top view of the main body in FIG. 4;

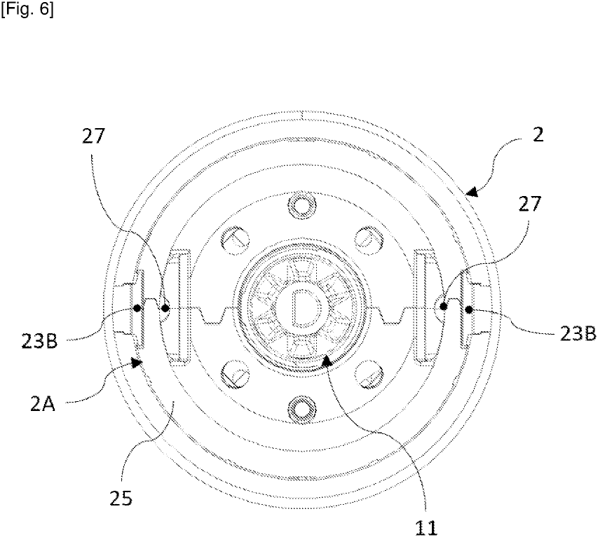

FIG. 6 depicts a bottom view of the massage head in FIG. 3;

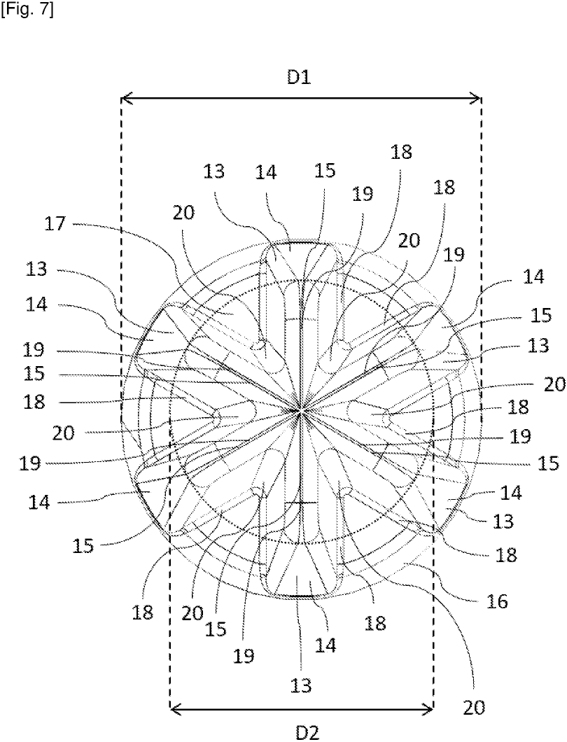

FIG. 7 depicts a top view of the first coupling member of the main body of the device in FIGS. 1 and 2, which in this case constitutes a male coupling member;

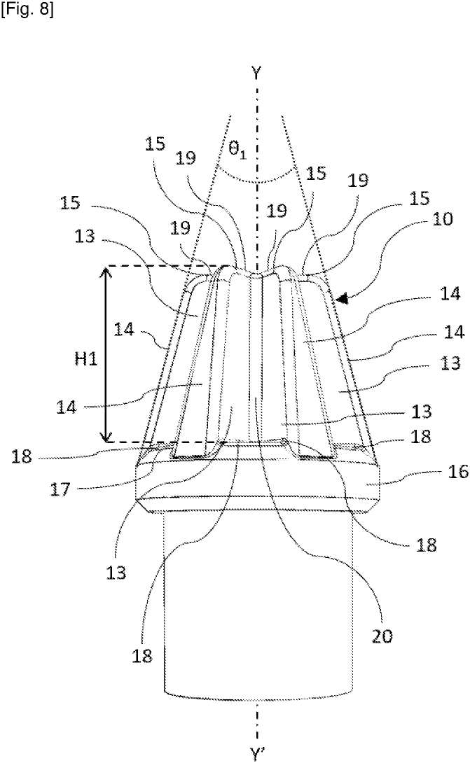

FIG. 8 depicts a side view of the male coupling member in FIG. 7;

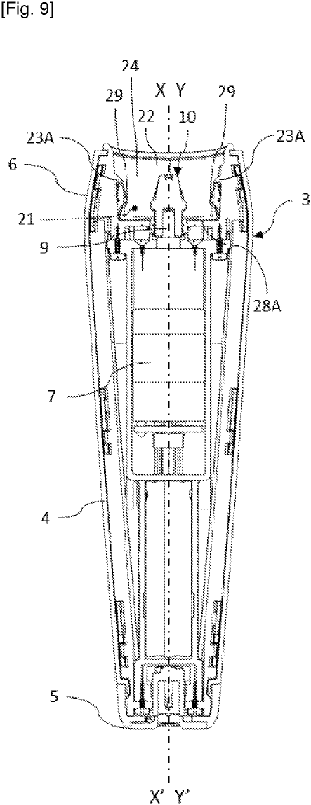

FIG. 9 depicts, in a sectional view A-A (see FIG. 1), the main body of the device in FIGS. 1 and 2;

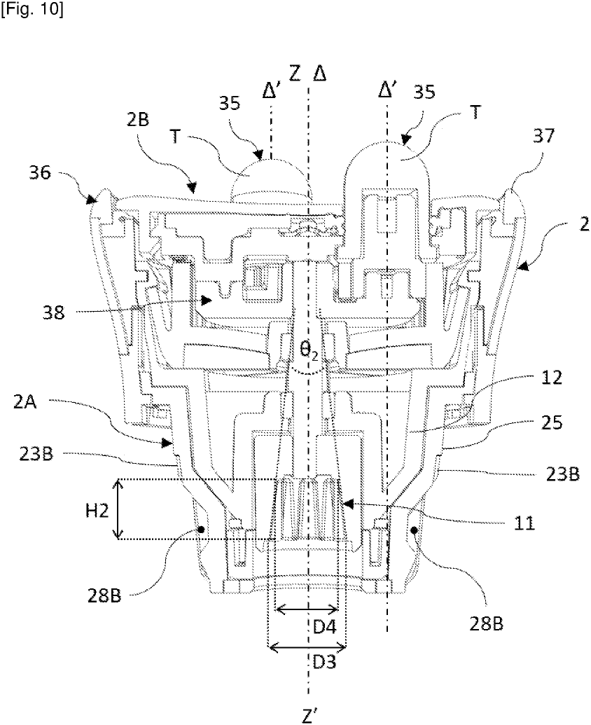

FIG. 10 depicts, in a sectional view A-A, the massage head of the device in FIGS. 1 and 2;

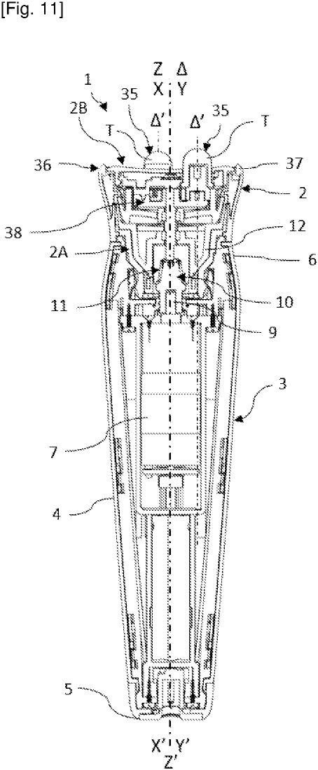

FIG. 11 depicts, in a sectional view A-A, the device in FIG. 1;

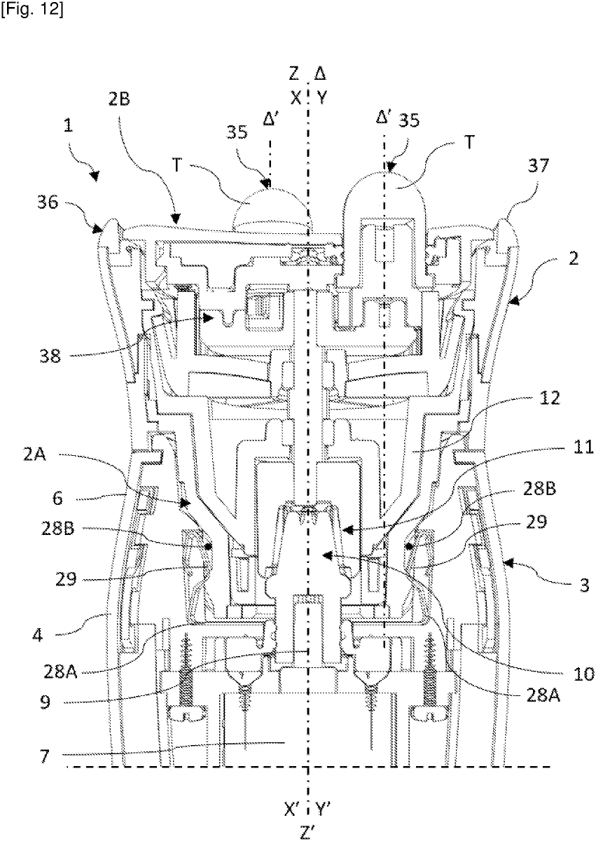

FIG. 12 depicts, in a partial section A-A view, a design detail of the device in FIG. 11;

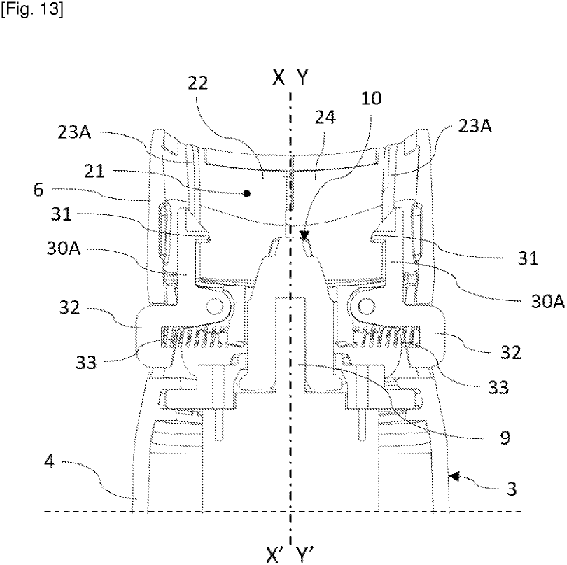

FIG. 13 depicts, in a sectional view A-A, a design detail of another embodiment of the main body of a device according to the invention;

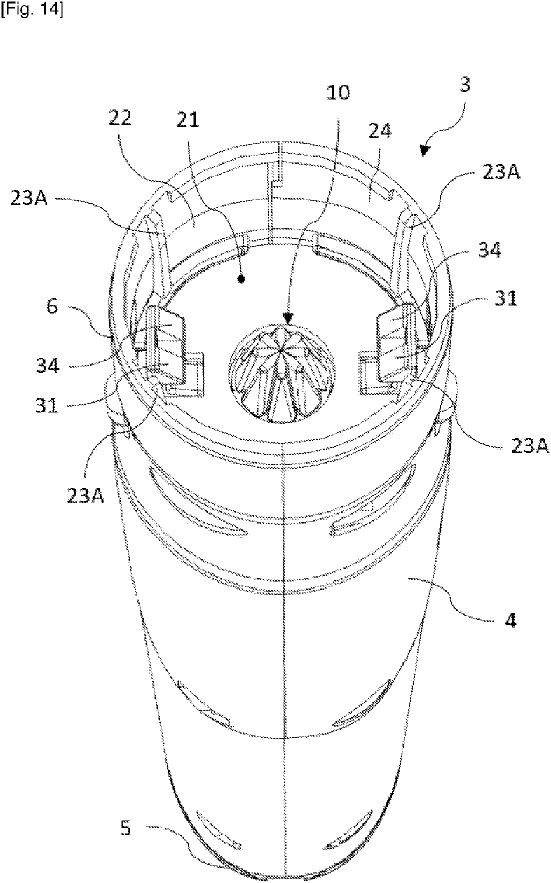

FIG. 14 depicts, in a top view in perspective, the main body in FIG. 13.

According to a first aspect, the invention relates to a skin care device 1, in particular a massage device 1, in particular intended for facial skin massage; said skin care device 1 comprises on the one hand at least one massage head 2, which is configured to be applied in contact with the skin and to provide the skin with a mechanical massage action and, on the other hand, a main body 3 to which said massage head 2 is intended to be removably attached. This therefore involves a care device 1, and in particular a skin massage device 1, whose massage head 2 is intended to be able to be detached by the user, in normal use of the device 1, for storage, maintenance or even replacement with another massage head (care device with interchangeable massage head). For example, this allows the user to be able to change the massage head 2 and to replace it at will with another massage head, with different features and therefore suitable for providing a different type of skin massage or for massaging another area of skin.

Preferentially, the care device 1 is designed for the user to use the device 1 on himself or herself, that is, on his or her own skin. However, it is perfectly conceivable that the device 1 could be designed for use by the user on the skin of a third party, without departing from the scope of the invention. Preferably, the massage device 1 according to the invention is intended for use in a home setting by a user who lacks specific professional skills in personal care, and more specifically in the area of skin massage. Its use is not particularly limited in terms of areas of the body likely to be treated, although the massage head 2 according to the embodiment illustrated in the figures is more preferentially intended for massaging an area of facial skin. More specifically, the illustrated massage head 2 can be considered as a head 2 for kneading the skin, particularly well suited for the treatment of the cheekbones, cheeks, the oval of the face (namely, the area between the jaws), the chin, or the neck.

The device 1 according to the invention is designed to be grasped and handled manually. As such, the main body 3 of the device 1 comprises a housing 4 forming a manual gripping area, by means of which the user can advantageously grasp the device 1 with the whole hand in order to use it. As illustrated in the figures, the main body 3 of the device 1, and in particular its housing 4, preferably extends longitudinally, along an extension axis X-X′, between a first free end 5 and a second opposite end 6 at which the massage head 2 is intended to be attached. As illustrated by the example in the figures, the main body 3, and in particular the housing 4 thereof, advantageously forms a solid body of revolution around said extension axis X-X′. The main body 3 preferentially has a general frustoconical shape that flares from the first free end 5 towards the second opposite end 6. Such a shape of the main body 3 makes the latter particularly ergonomic and well suited for the user to grip.

The main body 3 of the device 1 also comprises a motor 7, which is advantageously arranged inside the housing 4, to actuate the massage head 2 when the latter is attached to the main body 3. The main body 3 of the device 1 may further comprise a gear train forming a gearmotor with the motor 7. Preferably, the motor 7 is an electric motor, so that the care device 1 advantageously constitutes a portable electrical device 1. The device 1 may then advantageously further comprise a built-in power supply. The latter may, for example, comprise an array of replaceable or rechargeable electric batteries arranged within the housing 4 of the main body 3 of the device 1 to allow self-contained, portable use thereof, as in the embodiments depicted in the figures. The care device 1 then advantageously constitutes a wireless portable electrical device. In FIGS. 1 and 2, the device 1 is illustrated for example in combination with an electric charging base 8 provided for connection to the mains, and into which the main body 3 of the device 1 is intended to plug, via its first free end 5, in order to enable the charging of the array of electric batteries. In addition, such a base 8 allows the device 1 to be kept in a stable and space-saving vertical position, particularly when the device is stopped. Alternatively, the device 1 may comprise an electrical transformer, built-in or not, intended to be connected to a conventional electrical outlet via an external power cord (not shown).

The device 1 according to the invention further comprises a temporary mechanical coupling system, advantageously homokinetic, between the massage head 2 and the main body 3 to transmit to the massage head 2 a rotational movement of a shaft 9 driven by the motor 7 when the massage head is attached to the main body 3 (FIGS. 1 and 11). Said mechanical coupling system comprises a first coupling member 10 and a second coupling member 11, distinct from one another, and which respectively form part of the main body 3 and the massage head 2. One of said coupling members 10, 11 constitutes a male coupling member, while the other of said coupling members 10, 11 constitutes a female coupling member intended to, that is, shaped and configured to, receive (at least in part) the male coupling member within it to cooperate therewith in a form-fitting manner. In other words, the male and female coupling members are complementary, conjugate shapes, the female coupling member being shaped and configured to receive the male coupling member in an interlocking manner, such that when the male coupling member is received within the female coupling member, a rotation of the first coupling member 10 imparted to the latter via the shaft 9 drives the second coupling member 11 in rotation. The first coupling member 10 is mounted in a purely rotational manner relative to the housing 4 of the main body 3, around a first axis of rotation Y-Y′. In other words, the first coupling member 10 is secured, preferably permanently, to the housing 4, and has only a single degree of freedom vis-à-vis the latter, namely a degree of freedom in rotation around the first axis Y-Y′. Thus, the expression “in a purely rotational manner” denotes a rotatable coupling between the housing 4 and the first coupling member 10. Such assembly makes it possible, in particular, to simplify the design of the main body 3 and the device 1, and to make its operation reliable.

Respectively, the second coupling member 11 is advantageously rotatable in relation to a frame 12 of the massage head 2, according to a second axis of rotation Z-Z′, which advantageously coincides with the first axis of rotation Y-Y′ of the first coupling member 10 when the massage head 2 is attached to the main body 3 of the device 1 (FIGS. 1, 11 and 12). Advantageously, and for the same reasons set out above with regard to the first coupling member 10, the second coupling member 11 is respectively mounted in a purely rotational manner with respect to the frame 12 of the massage head 2. The second coupling member 11 thus has, vis-à-vis the frame 12 of the massage head 2, only a single degree of freedom, namely a degree of freedom of rotation around the second axis Z-Z′. In other words, the second coupling member 11 is therefore mounted rotatably with respect to the frame 12 of the massage head 2.

Such a limitation of the degrees of freedom of the first and second coupling members 10, 11 also advantageously contributes to improving the perceived quality of the assembly of the massage head 2 to the main body 3 and the operation of the device 1. For example, this makes it possible to limit, if not eliminate, the risk of noise generated during assembly and during operation of the device 1.

According to the invention, the male coupling member of the temporary mechanical coupling system, whether the first or second coupling member 10, 11, has a general conical or frustoconical shape. In other words, the male coupling member comprises at least a first portion that is intended to cooperate in a form-fitting manner with at least one corresponding first portion of the female coupling member, and which is of general conical or frustoconical shape. As shown in the figures, the general conical or frustoconical shape of the male coupling member (or at least said first portion thereof) preferably has a circular base, with an axis of revolution that coincides with the axis of rotation of the male coupling member (said axis of rotation therefore corresponds either to the first axis of rotation Y-Y′ of the first coupling member, or with the second axis of rotation Z-Z′ of the second coupling member). More specifically, the male coupling member includes a plurality of fins 13, which are distributed (and preferably equidistributed) around the axis of rotation of the male coupling member. Advantageously arranged in a star, as in the embodiments illustrated in the figures, the fins 13 have free edges 14, 15 that define the general conical or frustoconical shape of the male coupling member. Preferably, a general frustoconical shape of the male coupling member will be retained, insofar as it is capable of conferring greater mechanical strength on the male coupling member (since there is no cone peak that is likely to degrade rapidly over successive cycles of assembly/disassembly of the massage head 2 and the main body 3, or in the event the device 1 were to be dropped). In this case, the general frustoconical shape of the male coupling member is advantageously defined by free lateral edges 14 and free upper edges 15 which then constitute said free edges 14, 15 of the fins 13 (FIGS. 7 and 8 in particular). Reciprocally, the female coupling member of the mechanical coupling system, whether it is the second or first coupling member 11, 10 respectively, has a general conical or frustoconical shape, hollow, therefore complementary to the general conical or frustoconical shape of the male coupling member. In other words, the female coupling member comprises at least a first hollow portion that is intended to cooperate in a form-fitting manner with at least said corresponding first portion of the male coupling member, and which is of general conical or frustoconical shape. The female coupling member (or at least said first portion thereof) thus defines a cavity, a housing, an inner side wall of which has a general conical or frustoconical shape, shaped and configured to receive and cooperate with the fins 13 of the male coupling member in a form-fitting manner. As illustrated in the figures, the general conical or frustoconical shape of the female coupling member preferably has a circular base, with an axis of revolution that coincides with the axis of rotation of the female coupling member (said axis of rotation therefore corresponds either to the second axis of rotation Z-Z′ of the second coupling member 11, or to the first axis of rotation Y-Y′ of the first coupling member 10).

With such a mechanical coupling system, which is particularly simple in design, the massage head 2 can thus be assembled, attached to the main body 3 of the device 1 in a particularly easy and quick way by the user, even if the latter does not present the second coupling member 11 carried by the massage head 2 in a perfectly angular alignment with the first coupling member 10 carried by the main body 3. This then guarantees the user easy, quick and intuitive assembly of the massage head 2 to the main body 3, and thus an optimized interchangeability of different massage heads 2.

As illustrated for example in the figures, the axis X-X′ along which the main body 3 extends longitudinally is preferably parallel to or coincident with the first axis of rotation Y-Y′ of the first coupling member 10, which makes it possible to simplify the design of the main body 3, and therefore of the device 1, avoiding in particular the need for a bevel gear mechanism between the motor 7 and the first coupling member 10. This also contributes to the compactness of the device 1.

Advantageously, as in the embodiments illustrated in the figures, the first coupling member 10 constitutes said male coupling member, while the second coupling member 11 constitutes said female coupling member. This advantageously allows a more compact, lighter and more robust design of the massage head 2 of the device 1.

Preferably, the general conical or frustoconical shape of the male coupling member has a taper angle θ1 comprised between 15° and 45°, preferably comprised between 25° and 35°, and even more preferably equal to 29° ± 2°. As illustrated in FIG. 8, the taper angle θ1 therefore refers to the apex angle of a fictitious cone, which gives the male coupling member its general conical or frustoconical shape. This is therefore the angle θ1 formed between two free side edges 14 diametrically opposite with respect to the axis of rotation of the male coupling member. Reciprocally, the complementary general conical or frustoconical shape of the female coupling member preferentially has a taper angle θ2 that is comprised between 5° and 30°, preferably comprised between 10° and 20°, and even more preferably equal to 15° ± 2°. As illustrated in FIG. 10, the taper angle θ2 therefore refers to the apex angle of a fictitious cone, which gives the female coupling member its general conical or frustoconical shape. This is therefore the taper angle θ2 formed between two diametrically opposite portions, with respect to the axis of rotation of the female coupling member, of the inner side wall of the hollow cavity defined by the female coupling member.

The use of taper angles θ1, θ2 comprised within such preferential ranges of values, each taken alone or in combination, advantageously makes it possible to further facilitate the relative centering and coupling of the male and female coupling members when assembling the massage head 2 to the main body 3, even in the event of significant relative radial misalignment between said coupling members during assembly, while allowing a design of smaller size. Advantageously, the taper angle θ2 of the female coupling member is of a value lower than the respective value of the taper angle θ1 of the male coupling member so as to facilitate the coupling and uncoupling of the male and female coupling members while limiting the risk of wear thereof.

In order to further facilitate the coupling of the male and female coupling members, when assembling the massage head 2 to the main body 3, it is advantageous that said plurality of fins 13 comprise at least four fins 13. However, the use of too many fins 13 may prove detrimental in terms of the robustness of the mechanical coupling system, so that it is preferable that said plurality of fins 13 comprise at most twelve fins 13. A very good compromise between the ease of assembly and the robustness of the mechanical coupling system may be advantageously obtained when said plurality of fins 13 preferably comprises only six fins 13, as in the embodiments illustrated in the figures.

Preferably, the male coupling member comprises a base 16, from one surface 17 of which the fins 13 extend between a base end 18 and an opposite free end 19, each fin 13 having a thickness that decreases from the base end 18 towards the free end 19 of the fin 13. As in the example illustrated in the figures, said base 16 advantageously constitutes a second portion of the male coupling member, which axially extends the first portion of the conical or frustoconical general shape thereof. The coupling of the male and female coupling members is thus facilitated and the robustness of the fins 13 improved, said fins therefore having a greater thickness of material at their base end 16.

Advantageously, the free edges 14, 15 of the fins 13 of the male coupling member define a general frustoconical shape, as already mentioned above, having a large circular base with a diameter D1 comprised between 4 mm and 40 mm, and preferably comprised between 5 mm and 15 mm (for example, equal to 9.5 mm), and a small circular base with a diameter D2 comprised between 2 mm and 30 mm, and preferably comprised between 3 mm and 8 mm (for example, equal to 5.4 mm). Reciprocally, the female coupling member advantageously has a general frustoconical, hollow shape, a large circular base with a diameter D3 comprised between 5 mm and 41 mm, and preferably comprised between 6 mm and 16 mm (for example, equal to 10.2 mm), and a small circular base with a diameter D4 comprised between 3 mm and 31 mm, and preferably comprised between 4 mm and 9 mm (for example, equal to 7.8 mm).

The fins 13 of the male coupling member have, along the axis of rotation of the male coupling member, a height H1 that is preferentially comprised between 4 mm and 20 mm, preferably between 5 mm and 12 mm, even more preferably comprised between 7 mm and 9 mm (for example, equal to 7.2 mm). As illustrated in FIG. 8, said height H1 is advantageously measured from the surface 17 of the base 16 of the male coupling member, from which the fins 13 preferentially extend as described above. Advantageously, the complementary cavity, of a general conical or frustoconical shape, defined by the female coupling member, reciprocally has, along the axis of rotation of the female coupling member, a height H2 that is preferentially comprised between 5 mm and 21 mm, preferably comprised between 6 mm and 13 mm, even more preferably comprised between 7 mm and 9 mm (for example, equal to 7.3 mm) (FIG. 10). It should be noted here that it is particularly advantageous, in order to enable optimal coupling of the first and second coupling members 10, 11, that the dimensions of the female coupling member be slightly larger (typically from a few tenths of millimeters to a few millimeters) than the respective corresponding dimensions of the male coupling member.

Each of the above dimensional features contribute, as such, to conferring excellent robustness to the temporary mechanical coupling system between the massage head 2 and the main body 3, thus enabling the transmission of high torque, while maintaining a limited size of the mechanical coupling system, easy assembly and good perceived overall quality (limited noise, etc.).

Advantageously, as shown in the figures, the free edges 14, 15 of the fins 13 of the male coupling member are rounded. The lack of sharp edges at the free edges 14, 15 thus further facilitates the coupling and uncoupling of the male and female coupling members, and reduces the risk of premature wear of thereof.

As in the embodiments illustrated in the figures, it is advantageous, in terms of robustness and reliability of the male coupling member, that the fins 13 of the latter together form (by continuity of material) a monolithic part, as a single unit, said fins 13 then being preferentially connected together two by two, along the axis of rotation of the male coupling member, by a fillet 20. Such a lack of sharp edges between two consecutive fins 13 also contributes to further facilitating the coupling and uncoupling of the male and female coupling members and to reducing the risk of premature wear of the latter.

Irrespective of the number and dimensions of the fins 13 of the male coupling member 10, the care device 1 preferably has a total torque transmission surface by contact between the first and second coupling members 10, 11, that is., by contact between the male and female coupling members when the latter cooperate in a form-fitting manner, to transmit to the massage head 2 the rotational movement of the shaft 9 driven by the motor 7, which is comprised between 20 mm² and 140 mm², preferably comprised between 30 mm² and 90 mm², and even more preferably comprised between 35 mm² and 80 mm². Optionally, the respective free surface areas of the first and second coupling members 10, 11 may be different from one another, insofar as said total torque transmission surface corresponds to the sum of the surfaces at which the first and second coupling members 10, 11 are in contact with one another and through which a torque can actually be transmitted, when the massage head 2 is attached to the main body 3. Such dimensioning of said total contact torque transmission surface makes it possible to effectively transmit a significant torque, advantageously comprised between 30 mNm and 200 mNm (depending on the operating features of the massage head 2 associated with the main body 3), while maintaining a temporary mechanical coupling system of small size.

Preferentially, the main body 3 of the device 1 defines a housing 21 shaped and configured to removably receive the massage head 2, and thus to attach the massage head to the main body 3 in a reversible, temporary manner. In the embodiments illustrated in the figures, said housing 21 is thus advantageously defined at the second end 6 of the main body 3, so that the massage head 2 can thus be assembled, attached, to the main body 3 in the vicinity of said second end 6 thereof. Said housing 21 is thus advantageously defined by a side wall 22 that defines a free space within which at least one attachment portion 2A of the massage head 2 can be received, at least an active portion 2B of said massage head 2, intended to come in contact with the skin of the user, being then arranged outside said housing 21. In the preferential case mentioned above, where the first coupling member 10 constitutes a male coupling member, the latter thus extends axially within the housing 21, over only a portion of the height of the housing 21. The male coupling member is thus advantageously protected by the side wall 22, particularly in the event the main body 3 of the device 1 is dropped. In addition, the implementation of such a housing 21 advantageously makes it possible to facilitate the relative assembly of the massage head 2 and the main body 3, the side wall 22 forming a guide against which the massage head 2 can slide when the attachment portion 2A of the latter is inserted into the housing 21 by the user.

Although it can be of a general substantially cylindrical shape, for example, the housing 21 is preferably of a general frustoconical shape (with a circular base), as in the embodiments illustrated in the figures, the side wall 22 flaring towards the opening of the housing 21 through which the massage head 2 is intended to be inserted into the latter to be attached to the main body 3. Reciprocally, the attachment portion 2A of the massage head 2 may have a general frustoconical shape (with a circular base) complementary to the general frustoconical shape of the housing 21, so as to further facilitate the assembly of the massage head 2 and the main body 3 by the user.

Advantageously, the device 1 comprises rotational blocking and indexing means (or members), along the first axis of rotation Y-Y′ of the first coupling member 10, of the massage head 2 within the housing 21 of the main body 3. This comprises, on the one hand for example, one or more ribs 23A protruding from an inner face 24 of the side wall 22 and, on the other hand, one or more corresponding grooves 23B arranged in an outer surface 25 of the attachment portion 2A of the massage head 2, said rotational blocking means making it possible to effectively transfer the mechanical forces exerted in rotation when the device 1 is in operation, and to rotationally immobilize the frame 12 of the massage head 2 relative to the housing 4 of the main body 3.

Said rotational blocking means may optionally constitute, as such, on their own, position indexing means (or “keyed”), shaped and configured to allow the assembly of the massage head 2 to the main body 3 only in a predefined number of positions of the massage head 2 relative to the main body 3. Such position indexing means advantageously allow the user to intuitively identify the relative arrangement(s) of the massage head 2 and the main body 3 that must be used.

Optionally, as in the embodiment in FIGS. 1 to 12, said rotational blocking means may, as such, constitute position indexing means of a first massage head 2 in a plurality of predetermined positions. However, the main body 3 of the device 1 may advantageously comprise a first additional indexing means 26A shaped and configured to cooperate with a second complementary indexing means, which may respectively be provided with a second massage head (not shown) of the device 1, to allow the assembly of the second massage head to the main body 3 only in a single predetermined position. This thus advantageously makes it possible to use the same main body 3 in combination alternatively with a first massage head 2 (such as the one shown in the figures) whose operation does not require a particular unique position of the massage head 2 in relation to the main body 3, and with at least one second massage head, different from the first massage head 2 and whose operation, or as a minimum at least optimal operation, requires assembly of the massage head in a particular unique position relative to the main body 3. For example, such a first means 26A of additional indexing may include a single lug or protrusion arranged within the housing 21, for example protruding from the inner face 24 of the side wall 22 as illustrated for example in FIGS. 4, 5 and 9 in particular or at the bottom of the housing 21. Respectively, the second complementary indexing means may comprise a single depression, formed in an external surface 25 of the attachment portion 2A of the massage head 2 and shaped and configured to receive the lug or protrusion forming said first additional indexing means 26A when the second massage head is assembled to the main body 3. It is understood, however, that it should then be provided that the assembly of the first massage head 2, or any other massage head capable of being attached to the main body 3 in a plurality of distinct relative positions, is not impeded by the presence of the first additional indexing means 26A. For this reason, the massage head 2 illustrated in the figures is provided with two depressions 27, formed in the outer surface 25 of the attachment portion 2A of the massage head 2, and each shaped and configured to alternately receive the protrusion, forming said first additional indexing means 26A, which protrudes from the inner wall 24 of the side wall 22 defining the housing 21.

In order to attach the massage head 2 to the main body 3, the care device 1 comprises, according to a preferential variant used in the embodiment in FIGS. 1 to 12, removable snap-on means of fastening the massage head 2 to the main body 3. As such, said fastening means preferentially comprise at least one part 28A with elastically deformable pin(s) 29 (by a metal spring blade) and at least one corresponding notch 28B shaped and configured to receive said pin 29, when the massage head 2 is received in housing 21 of the main body 3. Preferably, the part 28A with elastically deformable pin(s) 29 is integral with the main body 3 (FIGS. 4, 5, 9, 11 and 12), while the corresponding notch 28B is preferentially formed in a surface of the massage head 2, and preferably in the outer surface 25 of the attachment portion 2A of the massage head 2. As illustrated in the figures, the fastening means 28A, 28B may advantageously comprise a single elastically deformable part 28A provided with two pins 29, each intended to cooperate with a corresponding notch 28B. Such removable snap-on means for fastening the massage head 2 to the main body 3 are of a particularly simple and robust design, and allow the user to attach and detach the massage head 2 from the main body 3 very easily.

FIGS. 13 and 14 illustrate a design detail of another embodiment of the main body 3 of a care device 1 according to the invention. As illustrated in these figures, the care device may comprise, according to another variant, instead of the snap-on attachment means described above, means 30A of removably attaching the massage head 2 to the main body 3, comprising:
at least one rigid lever 30A with pin 31, which is integral with the main body 3 and is pivotally mounted relative to the main body between a locked position (shown in FIGS. 13 and 14) in which the pin 31 of the lever 30A cooperates with a corresponding notch formed in a surface of the massage head 2, and at least one unlocked position (not shown) in which the pin 31 of the lever 30A does not cooperate with said notch, and
a manual control means 32 connected to said lever 30A to allow the user of the device 1 to control a pivoting of the lever 30A from said locked position to said unlocked position, and thus allow the detachment of the massage head 2.

As illustrated in FIGS. 13 and 14, the fastening means 30A may advantageously comprise two rigid levers 30A with pin 31, each intended to cooperate with a corresponding notch arranged in a surface of the massage head 2, and two separate manual control means 32, advantageously arranged diametrically opposite with respect to the longitudinal extension axis X-X′ of the main body 3, and each connected to one of said levers 30A.

Advantageously, said fastening means 30A further comprise an elastic return member, such as a compression spring 33, to automatically return the lever 30A to said locked position when said lever 30A occupies said unlocked position. For example, the manual control means can take the form of a button 32, accessible to the user from outside the housing 4 of the main body 3.

Advantageously, the lever 30A, the pin 31 and the control means together form (by continuity of material) a single, monolithic part, in one piece.

The lever(s) 30A are advantageously provided with a surface forming a ramp 34, shaped and configured to cooperate with a corresponding surface of the massage head 2, such that when the user inserts the massage head 2 into the housing 21 of the main body 3, said ramp 34 is capable of coming into contact with said corresponding surface of the massage head 2 in order to rotate the lever 30A towards its unlocked position, if applicable against the force exerted by the elastic return member.

Such removable means of attachment of the “toggling” and manually controllable massage head 2 to the main body 3 advantageously have the advantage of limiting the risk of unintentional detachment of the massage head 2, especially during use. Indeed, the massage head 2 cannot be detached if no positive action is exerted by the user against the manual control means.

Of course, other suitable means of removable attachment of the massage head 2 to the main body 3 can be considered, without necessarily departing from the scope of the invention.

As can be understood from reading the foregoing, said at least one massage head 2 of the care device 1 may have diverse and varied conformations and configurations, depending in particular on the nature of the skin massage that the user wishes to perform, but also possibly depending on the area of skin concerned by the massage to be performed.

Advantageously, the massage head 2 comprises, at a portion 2B referred to as “active” in the foregoing, a plurality of massage means 35 (or “working heads”) such as rollers, beads or pins, that have a work surface intended to come in contact with the user’s skin, at least one of the massage means 35 being intended to be driven in rotation by the motor 7 to allow a skin massage, when the massage head 2 is attached to the main body 3 and the male and female coupling members of the temporary mechanical coupling system between the massage head 2 and the main body 3 cooperate in a form-fitting manner. The massage head 2 is therefore designed to provide a mechanical massage of the skin by moving at least the massage means 35 driven in rotation against the skin, the massage head 2 then remaining advantageously in continuous contact with the skin.

In the non-limiting embodiment illustrated in the figures, the massage head 2 thus advantageously comprises:
a bearing element 36, which is intended to come against the skin, and for example against the skin of the face, and which forms a bearing ring 37, which defines on the one hand a bearing surface falling within a bearing plane and, on the other hand, a work area located inside the bearing ring 37,
inside said bearing ring 37 and in said work area, three working heads 35, one distal end of which is advantageously rounded or hemispherical, and each of which have a work surface T extending at least partly protruding from the bearing plane.

The massage head 2 further comprises maneuvering means 38 adapted to move each working head 35 in rotation along a Δ axis that is offset relative to the center of each corresponding work surface T. The maneuvering means 38 are mechanically connected to the second coupling member 11 of the temporary mechanical coupling system of the device 1 (said second coupling member 11 in this case constitutes the female coupling member of the temporary mechanical coupling system), such that rotating the second coupling member 11 around the second axis of rotation Z-Z′ causes each working head 35 to rotate along the Δ axis. The Δ axis in this case advantageously coincides with said second axis Z-Z′.

In the embodiment illustrated in the Figures, the means 38 of maneuvering the massage head 2 are further advantageously adapted to move each working head 35 in a planetary motion, that is, both according to a main rotational movement around the Δ axis (or main axis of rotation Δ) offset from the center of each corresponding work surface T, but also simultaneously according to a secondary rotational movement around a secondary axis of rotation Δ′ that moves in rotation around the main axis of rotation Δ during operation of the device 1. The secondary axis of rotation Δ′ is in this case advantageously parallel to the main axis of rotation Δ, while the main axis of rotation Δ coincides with the second axis of rotation Z-Z′ of the second coupling member 11.

According to another aspect, the invention also concerns, as such, a massage head 2 for a skin care device 1 according to the invention wherein the first coupling member 10 of the temporary mechanical coupling system between the massage head 2 and the main body 3 constitutes the male coupling member, while the second coupling member 11 constitutes said female coupling member, as described above as a preferential variant of the device 1 according to the invention. This therefore involves a massage head 2 shaped and configured to be able to be attached in a removable manner, detachable, to a main body 3 having a first coupling member 11 that constitutes a male coupling member intended to be received by the female coupling member of the massage head 2 in order to cooperate with said female coupling member in a form-fitting manner, so as to allow the transmission to the massage head 2 of a rotational movement of a shaft 9 driven by a motor 7 in the main body 3.

More specifically, the female coupling member (or as a minimum at least a first portion thereof) of the massage head 2 according to the invention has a general conical or frustoconical shape, and preferably frustoconical, having a taper angle θ2 comprised between 5° and 30°, preferably comprised between 10° and 20°, and even more preferably equal to 15° ± 2°. The taper angle θ2 advantageously meets the definition already made of it in connection with the description of the device 1 according to the invention.

Therefore, complementary to the respective general conical or frustoconical shape of the male coupling member (or as a minimum at least a first corresponding portion thereof) of the main body 3, the general conical or frustoconical shape of the female coupling member of the massage head 2 thus defines a hollow shape, a cavity, shaped and configured to receive within it a plurality of fins 13 that the male coupling member of the main body 3 comprises; said fins 13 have free edges 14, 15 that define the general conical or frustoconical shape of the male coupling member, as already discussed above.

In addition to the aforementioned feature with regard to the value of the taper angle θ2 of the general conical or frustoconical shape of the female coupling member, the massage head 2 may comprise all or part of the technical features of the massage head 2 described previously in connection with the device 1 according to the invention. FIGS. 1 to 3 and 10 to 12 illustrate, as such, an embodiment of a massage head 2 according to the invention.

Moreover, according to another aspect, the invention concerns, as such, a main body 3 for a skin care device 1 according to the invention wherein the first coupling member 10 of the temporary mechanical coupling system between the massage head 2 and the main body 3 constitutes the male coupling member, while the second coupling member 11 constitutes said female coupling member, as described above as a preferential variant of the device 1 according to the invention.

It is therefore a main body 3 to which at least one massage head 2 is intended to be removably attached in order to form a skin care device 1; said main body 3 comprises:
a housing 4 forming a manual gripping area and a motor 7 to actuate the massage head 2, and
a male coupling member, which is intended to be received within it by a female coupling member that comprises, respectively, at least one massage head 2 which is capable of being used in combination with said main body 3 to form a skin care device 1, to cooperate with said female coupling member in a form-fitting manner, said male and female coupling members thus forming a temporary mechanical coupling system between the main body 3 and the massage head 2 to transmit to the massage head 2 a rotational movement of a shaft 9 driven by the motor 7.

In accordance with what has been described above in connection with the device 1 according to the invention, the first coupling member 10 of the main body 3 according to the invention is mounted purely in rotation with respect to the housing 14 of the main body 3. Said male coupling member (or as a minimum at least a first portion thereof) has a general conical or frustoconical shape, and preferably frustoconical, and includes a plurality of fins 13 distributed around an axis of rotation Y-Y′ of the male coupling member, said fins 13 have free edges 14, 15 that define said general conical or frustoconical shape.

In addition to the aforementioned feature concerning the fact that the first coupling member 11 of the main body 3 specifically constitutes a male coupling member, the main body 3 may comprise all or part of the preferential technical features of the main body 3 described previously in connection with the device 1 according to the invention. FIGS. 1, 2, 4, 5, 7 to 9, 11 and 12 illustrate, as such, one embodiment of a main body 3 according to the invention, while FIGS. 13 and 14 illustrate, as such, another embodiment of a main body 3 according to the invention.

Advantageously, a massage head 2 according to the invention can be used in combination with a main body 3 according to the invention, in order to form together a particular embodiment of a skin care device 1 itself according to the invention, such as the one illustrated in FIGS. 1 and 2.

1. A skin care device comprising:
at least one massage head,
a main body to which said massage head is intended to be removably attached, said main body comprising a housing forming a manual gripping area and a motor for actuating the massage head, and
a temporary mechanical coupling system between the massage head and the main body for transmitting to the massage head a rotational movement of a shaft driven by the motor, said mechanical coupling system comprising a first coupling member and a second coupling member, which belong respectively to the main body and the massage head, one of said coupling members constituting a male coupling member, the other of said coupling members constituting a female coupling member intended to receive the male coupling member therein in order to cooperate with it in a form-fitting manner,
the first coupling member being mounted in a purely rotational manner relative to the housing of the main body, said male coupling member having a general conical or frustoconical shape and including a plurality of fins distributed around an axis of rotation of the male coupling member, said fins having free edges that define said general conical or frustoconical shape.

2. The care device according to claim 1, wherein said plurality of fins comprises at least four fins, preferably at most twelve fins (13), and preferably only six fins (13).

3. The care device according to claim 1, wherein the male coupling member comprises a base, from a surface of which the fins extend between a base end and an opposite free end, each fin having a thickness that decreases from the base end towards the free end of said fin.

4. The care device according to claim 1, wherein the free edges of the fins define a generally frustoconical shape, having a large circular base with a diameter (D1) comprised between 4 mm and 40 mm, and preferably comprised between 5 mm and 15 mm, and a small circular base with a diameter (D2) comprised between 2 mm and 30 mm, and preferably comprised between 3 mm and 8 mm.

5. The care device according to claim 1, wherein the fins of the male coupling member have, along the axis of rotation of the male coupling member, a height comprised between 4 mm and 20 mm, preferably comprised between 5 mm and 12 mm, even more preferably comprised between 7 mm and 9 mm.

6. The care device according to claim 1, wherein the general conical or frustoconical shape of the male coupling member has a taper angle comprised between 15° and 45°, preferably comprised between 25° and 35°, even more preferably equal to 29° ± 2°.

7. The care device according to claim 1, which has a total torque transmission surface by contact between the first and second coupling members that is comprised between 20 mm² and 140 mm², preferably comprised between 30 mm² and 90 mm², and even more preferably comprised between 35 mm² and 80 mm².

8. The care device according to claim 1, wherein the main body defines a housing shaped and configured to removably receive the massage head, said device comprising rotational blocking and position indexing means, along the axis of rotation of the first coupling member of the massage head within the housing of the main body.

9. The care device according to claim 1, wherein the free edges of the fins of the male coupling member are rounded.

10. The care device according to claim 1, wherein the fins of the male coupling member together form a monolithic part, said fins being preferentially connected to one another two by two along the axis of rotation of the male coupling member by a fillet.

11. The care device according to claim 1, wherein the main body extends longitudinally along an axis of parallel extension or coincident with the axis of rotation of the first coupling member.

12. The care device according to claim 1, which comprises removable snap-on attachment means of the massage head to the main body; said fastening means comprise at least one part with elastically deformable pin(s), preferentially integral with the main body, and at least one corresponding notch shaped and configured to receive said pin, said notch being preferentially formed in a surface of the massage head.

13. The care device according to claim 1, wherein the first coupling member constitutes said male coupling member, while the second coupling member constitutes said female coupling member.

14. A massage head for a skin care device according to claim 13, wherein said female coupling member has a general conical or frustoconical shape having a taper angle comprised between 5° and 30°, preferably comprised between 10° and 20°, and even more preferably equal to 15° ± 2°.

15. A main body for a skin care device according to claim 13.
